(19) United States
(12) Patent Application Publication
(10) Pub. No.: US 2016/0354729 A1
(43) Pub. Date: Dec. 8, 2016

(54) MEMBRANES COMPRISING GRAPHENE

(71) Applicant: GENERAL ELECTRIC COMPANY, Schenectady, NY (US)

(72) Inventors: Kalaga Murali KRISHNA, Bangalore (IN); Arjun BHATTACHARYYA, Bangalore (IN); Rebika Mayanglambam DEVI, Bangalore (IN); Madhuri PHADKE, Bangalore (IN)

(73) Assignee: General Electric Company, Schenectady, NY (US)

(21) Appl. No.: 14/880,986

(22) PCT Filed: Apr. 12, 2013
(86) PCT No.: PCT/US2013/036348

§ 371 Date: Oct. 12, 2015

(51) Int. Cl. B01D 69/14; B01D 61/14; B01D 65/08; B01D 71/38; B01D 67/00; B01D 71/02; B01D 71/56; B01D 61/02; B01D 69/12

(52) U.S. Cl. CPC B01D 69/148; B01D 61/025; B01D 61/027; B01D 61/145; B01D 65/08; B01D 69/125; B01D 67/0079; B01D 67/0097; B01D 71/021; B01D 71/56; B01D 71/38; B01D 2325/36; B01D 2323/28; B01D 2323/18; B01D 2323/30

(57) ABSTRACT

A selective membrane, for example an ultrafiltration, nanofiltration or reverse osmosis membrane, has a layer comprising flakes of graphene, graphene oxide, reduced graphene oxide, or functionalized variations. The flakes may form a layer themselves, be embedded in the surface of a layer of another compound, or be dispersed in a layer of another compound. In some cases, the flakes functions as a selective membrane. In other cases, the flakes modify the properties of a membrane, for example by making the membrane more hydrophilic. In yet other cases, the flakes function as a bonding agent between layers of a membrane.

### BACKGROUND

This specification relates to filtering membranes, for example membranes useful for reverse osmosis, nanofiltration or ultrafiltration, and to methods of making them.

Graphite is a mineral and an allotrope of carbon. Graphene is a flat monolayer of sp2-bonded carbon atoms. Graphene can be formed by exfoliating graphite and is sometimes described figuratively as a single isolated layer of graphite. Graphene tends to be structurally unstable. However, a flat monolayer of carbon with some edge bound functional groups is more stable and may still be referred to as graphene in some contexts.

Graphite oxide, also called graphitic oxide, is a crystalline compound of carbon, oxygen and hydrogen in varying ratios obtained by exposing graphite to oxidizers. Graphene oxide (GO) is a flat monolayer form of graphitic oxide that may be formed by exfoliating graphitic oxide. Graphene can be formed by reducing graphene oxide. Thus, as an alternative to exfoliating graphite, graphene may be formed by converting graphite to graphitic oxide to graphene oxide to graphene. Graphene produced by this route tends to have many residual non-carbon atoms and is sometimes referred to as reduced graphene oxide (rGO) to distinguish it from more nearly pure graphene or so called pristine graphene.

U.S. Pat. No. 3,457,171 describes the use of a dilute suspension of graphitic oxide particles for making a desalination membrane. The suspension is deposited on a porous substrate and forms a film less than 25 microns thick, for example about 0.25 microns thick. With thicker films, no water flows through the film even at very high pressures. The graphitic oxide film may be strengthened by adding a bonding agent. In an example, a mixture comprising polyvinyl resin and a cross linker was poured onto a bed of moist graphitic oxide that had been previously deposited on the surface of a filter paper disc supported in a suction filter. The resulting structure was dried, baked, immersed in fresh water and then used in a reverse osmosis pressure cell.

US Patent Application Publication No. 2010/0105834 describes a method of producing graphene nanoribbons from carbon nanotubes. The method includes reacting the nanotubes with an oxidant so as to longitudinally open the nanotubes to form flat ribbons of graphene. The publication states that a dispersion of graphene nanoribbons in at least one solvent may be filtered through a porous membrane to form a porous selective mat.

US Patent Application Publication No. 2012/0048804 describes perforating a graphene sheet by laser-drilling or selective oxidation. A single layer graphene sheet may have perforations dimensioned to pass water molecules but exclude salt ions. The perforated graphene sheet is applied to a backing structure to create a desalination membrane.

### SUMMARY OF THE INVENTION

In this specification, the words graphene compound include graphene, graphene oxide (GO) and reduced graphene oxide (rGO) and further functionalized variations thereof. This specification describes a solid-liquid separation membrane comprising an arrangement of one or more graphene compounds. The membrane may be, for example, a reverse osmosis, nanofiltration, ultrafiltration or microfiltration membrane.

The graphene compound is used in the form of a deposit of flakes (alternatively called crystallites or powder or particles or lamellae) in a layer. The flakes may form a layer substantially by themselves, or the flakes may be embedded in the surface of a layer of another compound, or the flakes may be dispersed in a layer of another compound. In some cases, the flakes function as a selective membrane. In other cases, the flakes modify the properties of a membrane, for example by making the membrane more hydrophilic. In yet other cases, the flakes function as a bonding agent between layers of a membrane.

In one method of depositing the flakes in a layer, the flakes are dispersed in water, an aqueous solution or a solvent. The dispersion may be applied to a substrate, for example by spray coating, rod coating or filtration deposition. In another method of depositing the flakes, the flakes are applied to the surface of another compound before that compound is fully solidified. In another method of depositing the flakes, the flakes are dispersed in a compound which is later solidified to form a layer.

### BRIEF DESCRIPTION OF THE DRAWINGS

FIG. 1 is a schematic cross section of a membrane having a supporting membrane layer and a barrier membrane layer with the barrier membrane layer having an embedded graphene compound.

FIG. 2 is a schematic cross section of a membrane having a supporting membrane layer and a barrier membrane layer with the surface of the supporting membrane layer and the barrier membrane layer both having an embedded graphene compound.

FIG. 3 is a schematic cross section of a membrane having a supporting membrane layer, a barrier membrane layer and a layer having a graphene compound embedded in a polymer.

FIG. 4 is a schematic cross section of a membrane having a supporting membrane layer and a barrier layer made up primarily of one or more graphene compounds.

FIG. 5 is a schematic cross section of a membrane having a supporting membrane layer and a barrier layer made up primarily of one or more graphene compounds with the surface of the supporting layer having an embedded graphene compound.

FIG. 6 is a schematic cross section of an integral membrane having an embedded graphene compound.

FIG. 7 is a schematic cross section of an integral membrane having a graphene compound embedded in its surface.

### DETAILED DESCRIPTION

Pristine graphene is a flat single layer of sp2-bonded carbon atoms. However, graphene tends to be unstable unless it has some edge bound functional groups. The word graphene will be used in this specification to include structures produced in a manner that inherently creates edge bound functional groups or provides edge bound groups in a separate functionalization step. The words graphene compound will be used to include graphene and similar structures, such as graphene oxide (GO) and reduced graphene oxide (rGO), that may also have functional groups in their basal plane, as well as further functionalized variations of graphene, GO and rGO. A graphene compound may also have one or more, for example between one and ten or between one and four, layers of carbon atoms rather than being strictly limited to monolayer structures. However, even multi-layer flakes of a graphene compound typically have length and width dimensions that are greater than their thickness. The flakes are small, more particularly microscopic, particles.

Flakes of a graphene compound may be synthesized from graphite directly or by first forming graphite oxide. In a direct method, graphite particles are added to a liquid. This mixture is ultrasonicated to produce flakes. In an embodiment, the flakes are monolayer graphene, however, up to four layers can be included as graphene for the purposes of making membranes. The liquid may be an organic solvent with high surface tension to prevent re-aggregation of the flakes. Alternatively, the liquid may be a water-surfactant solution. The surfactant compensates for repulsion between the water and graphene.

In an alternative synthesis method, graphite particles are first oxidized to produce graphite oxide particles. Graphite oxide can be made by exposing graphite to concentrated acids and strong oxidants. The oxidation may be performed by exposing the graphite particles to sulfuric acid (H2SO4), potassium permanganate (KMnO4) and hydrogen peroxide (H2O2). Alternative oxidation methods include the Staudenmaier method (using sulfuric acid with fuming nitric acid and KClO3), the Hofmann method (using sulfuric acid, concentrated nitric acid and KClO3) and the Hummers and Offeman method (using sulfuric acid, sodium nitrate and potassium permanganate).

The graphite oxide particles are then exfoliated to produce graphene oxide (GO). More particularly, the graphite oxide particles are exfoliated by sonicating a suspension of graphite oxide particles. Thermal or microwave exfoliation may also be used. Alternatively, Graphite oxide can be exfoliated in a base but the resulting GO is likely to have more structural or chemical defects than sonicated GO. In an embodiment, GO is a monolayer, but sonicated graphite oxide may have 2, or up to 4, layers and still be considered GO for use in membranes. Each GO layer is about 0.9 to 1.3 nm thick. GO is hydrophilic and once exfoliated disperses readily in water.

In one example, GO was made by placing 2 g of graphite into a 1 L round bottom flask. The flask was kept in an ice bath while 50 mL of concentrated sulfuric acid was added to it. The, 7 g of KMnO4 was added to this mixture slowly such that the temperature did not exceed 10° C. The resulting solution was stirred for four hours followed by heating at 35° C. for two hours. 100 mL of deionized (DI) water was added to this mixture. The water was added slowly while keeping the flask in an ice bath to keep the temperature of the solution below 50° C. The resultant solution was further diluted with 200 mL of DI water and stirred for another two hours. After that, 4 to 5 mL of 30% H2O2 was added to the solution drop wise until effervescence stopped. The resultant mixture was a light brownish color. This mixture was washed thoroughly with approximately 1 L of 5% HCl and centrifuged. The solids portion was washed with DI water and centrifuged again. Then the solids portion was washed again with D1 water using a sintering filter until the pH of the wash water was near 6. A resulting brownish solid was dried in an oven at 60° C. for 12 hours.

GO flakes can be used for making membranes without further modifications. Alternatively, the GO flakes may be reduced to form rGO or graphene. The reduction may be performed by exposing GO to potassium hydroxide (KOH) and hydrazine (NH2NH2). The reduction is primarily accomplished by exposure to hydrazine hydrate at near 100 degrees C. for up to 24 hours. Exposing the GO to potassium hydroxide before hydrazine reduction helps to stabilize edge bound carboxyl groups. Alternative reduction methods include exposure to hydrogen plasma, thermal shock and exposure to a strong flash of light or a laser.

GO has functional groups, typically epoxide, hydroxyl, carboxyl and carbonyl groups, on its edges similar to stabilized graphene. However, GO also has oxygen molecules in the form of epoxide groups on its surface. Exposure to hydrazine breaks the oxygen molecules into OH and NH—NH2. After N2H2 and H2O are removed, only the functional groups on the edges remain. At least some of these groups may be left in place and used for further functionalization. In embodiments, GO and rGO are used instead of graphene flakes for making membranes because of the functional groups, their hydrophilicity, the comparative ease of synthesis of GO and rGO, and their stable dispersion in water.

Graphene compound flakes may be attached to a porous substrate by filter deposition. In a laboratory scale coating, rGO dispersion was placed in a funnel on the upper surface of an alumina membrane filter. The membrane was sealed to the top of a filtration flask connected to a vacuum. This produced membrane test coupons having a film of rGO flakes attached to the alumina membrane. In another laboratory scale coating, a dispersion of rGO flakes was spray coated onto a test coupon. Other coating methods such as casting, rod coating, or dip coating may also be used.

The graphene compound may be functionalized by using its carboxyl, hydroxyl, carbonyl or epoxy groups. For example, a carboxyl group on a graphene compound can be reacted with the hydroxyl end group on a polyethylene glycol (PEG) molecule to provide a PEG functionalized graphene compound, for example GO-PEG. A graphene compound functionalized with PEG, or another hydrophilic moiety, can increase the flux and anti-fouling properties of a membrane.

In other examples, a graphene compound may be functionalized with an acyl chloride group, a sulphonyl chloride or an amine group. An acyl chloride group can be added by reacting a carboxyl group on a graphene compound, for example GO-COOH, with thionyl chloride (SOCl2) to produce, for example, GO-COCl. In another example, GO-COOH and (HO-PEG-OH)/PEG-OCH3 are reacted with para toluene sulphonic acid (PTSA) to produce GO-COO-PEG-OH.

In another example, GO is functionalized with amine groups. An aqueous solution of 3 g of GO in 200 mL of water is sonicated for 30 minutes and then stirred in a round bottom flask. 10 mL of 1N KOH solution is added to the flask and the mixture is sonicated for another 15 minutes. 3 g of diethylene triamine dilute with 7 mL of water is then added drop wise into the flask. The reaction mixture is then stirred and heated at 90° C. for 2 days.

Although it is beneficial for membrane flux that GO, rGO and some other graphene compounds are hydrophilic, this property also makes them susceptible to being washed or leached out of a membrane. This problem can be managed by one or more of a) crosslinking or otherwise bonding the flakes to each other, to a compound in an adjacent layer, or to a matrix compound, b) applying a coating over the flakes, or c) embedding the flakes in a matrix compound. In options a) and c), the matrix compound may be a membrane.

According to one method, a graphene compound is functionalized with carbonyl chloride (—COCl) groups and used with a thin film composite (TFC) polyamide membrane. TFC membranes may be made by interfacial polymerization over a supporting membrane layer, for example an ultrafiltration or microfiltration membrane. The graphene compound may be GO-COCl prepared as described further above. Flakes of the functionalized graphene compound are mixed in a solution with at least one of the reactants used to make the TFC barrier membrane or applied over the reactants before the polymerization is complete. The graphene compound becomes cross linked to the membrane by covalent bond between the carbonyl chloride groups and the polyamide to inhibit the flakes from leaching out in use. Optionally, the graphene flakes may be embedded in a matrix of the polyamide.

In an example, a TFC membrane can be made by interfacial polymerization of a polyamine, for example m-phenylenediamine (MPD), and a polyacid halide, for example trimesoyl chloride (TMC). The MPD is provided in a 2 wt % aqueous solution. The TMC is provided in a 0.2 wt % solution in an organic solvent, for example an ester or hydrocarbon solvent. Flakes of a graphene compound, for example GO-COCl, are dispersed in the organic solution. A TFC membrane is formed by dipping a Polysulphone ultrafiltration membrane support in the MPD solution for about two hours. The saturated support is removed and held vertically to drain for 3 minutes and then immersed in the TFC solution for about two minutes. A thin film polyamide membrane forms on the support. The resulting composite membrane is heat cured at 90° C. for about 3 minutes. The cured membrane is stored for about 24 hours at ambient temperature and then washed with distilled water and stored in fresh distilled water at ambient temperature. The graphene compound is cross linked in situ while being embedded in the polyamide layer. The cross linked structure is as shown below:

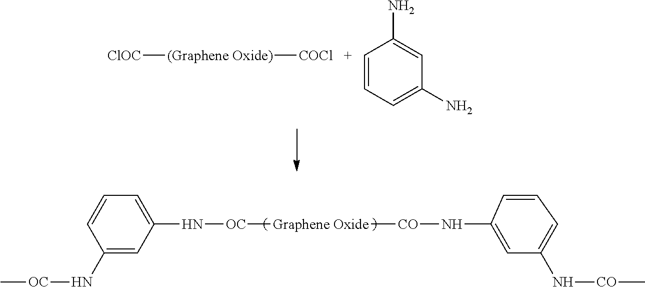

In the example above, the GO-COCl or another form of GO or rGO may alternatively or additionally be dispersed in the aqueous solution. In a production environment in which the reactants are cast onto a moving textile covered with an ultrafiltration membrane, it is expected that the flakes may be coated over the reactants before they have fully reacted or at least before the polyamine is cured. Whether the graphene compound is dispersed into one or both of the reactant solutions, or applied over the coating, GO or rGO, whether additionally functionalized or not, may be used, in embodiments, since the hydrophobic nature of these graphene compounds allows them to be more widely and evenly dispersed in the resulting polyamide. As an alternative to GO-COCl, amine functionalized GO can also be used and form a crosslinking network during polyamide TFC formation. Other graphene compounds functionalized with amine or carbonyl chloride groups may also be used.

According to another method, a graphene compound is embedded in, and optionally crosslinked to, a polymer other than a TFC polymer. For example, the polymer may be a thermosetting polymer. This polymer may be used over a TFC membrane layer in a nanofiltration or reverse osmosis membrane. Alternatively, a sufficient density of one or more graphene compounds may be embedded in the polymer to allow it to function as a barrier layer in a nanofiltration or reverse osmosis membrane.

Suitable matrix polymers include, for example, cross linked polyvinyl alcohol (PVA), polyvinyl sulfate (PVS), chitosan, a co-polymer of N-isopropyl acrylamide (NIPAAm) and acrylic acid (AA), a co-polymer of NIPAAm and Acryl amide, polyvinyl acetate (PVAc), Flosize 189 (colloidal solution-Vicol 1200) and poly(vinyl methyl ether) (PVME), all with or without a cross linker. The graphene compound may be cross linked to the polymer, for example with ethylene diamine tetra propoxalate (EDTP) or polyamide epichlorohydrin (PAE).

In an example, a layer of graphene compound flakes is dispersed in polyvinyl alcohol (PVA). A solution is made with 5 g of PVA (for example with a molecular weight 2,005,000; hydrolysis 86% and above) and 0.25 g of a cross-linker such as ethylene diamine tetra propoxylate (EDTP) in 1000 mL of deionized (DI) water. In an embodiment, the water is heated, for example to 90 degrees C., with constant stirring for 15-30 minutes. The pH may be between 7.5 and 7.8. Separately, 1000 mL of a 1 wt % dispersion of flakes of one or more graphene compounds is prepared. This dispersion is mixed with the PVA solution. The resulting mixture is added to 8 L of DI water to provide a coating solution. The coating solution can be applied to a microfiltration or ultrafiltration supporting membrane by filtration deposition. For example, the coating solution can be circulated through the supporting membrane at 30 psi and 25 degrees C. for 30 minutes. The coating solution is then removed and DI water is recirculated through the supporting membrane for 30 minutes and then flushed for 2 to 3 minutes. The coated membrane is then placed in a sealed container for curing, for example for 24 hours. The resulting layer of PVA with embedded graphene compounds may be used for reverse osmosis or nanofiltration.

A TFC or other polymeric matrix as described above may be used to provide a reverse osmosis or nanofiltration barrier layer. This barrier layer may be formed over a support membrane which in turn may be formed over a fabric. The resulting layer may be made into a spiral wound membrane element and used, for example, for desalination. Other membrane configurations and uses are also possible.

In another method, a graphene compound may be embedded in a porous polymeric or ceramic matrix. A polymeric matrix may be made porous, for example, by a thermally induced phase separation (TIPS) or non-solvent induced phase separation (NIPS) process. The porous matrix may provide an ultrafiltration or microfiltration membrane. This membrane may be used alone or as a support for a reverse osmosis or nanofiltration membrane. For example, a polysulphone ultrafiltration membrane support may have one or more graphene compounds embedded in it and may be used alone or as a support for a TFC or other polymeric layer with an embedded graphene compound.

One or more graphene compounds may be dispersed generally evenly throughout a matrix compound layer. Alternatively, one or more graphene compounds may be applied to the surface of a matrix compound before it is fully cured. In this case, the graphene compound becomes embedded in the surface of the matrix and may also be dispersed to some extent near but below the surface of the polymer. The graphene compound may provide a further separation layer, may functionalize the surface of the matrix, may increase electro-static salt rejection, or may make the matrix surface more hydrophilic. A sufficient density of one or more graphene compounds may be embedded throughout or near the surface of a matrix to convert, for example, a microfiltration membrane to an ultrafiltration membrane or an ultrafiltration membrane to a nanofiltration membrane.

When used as a coating over another membrane layer, or embedded in a membrane layer, the flakes may increase the hydrophilicity of a membrane to a degree related to the amount of flakes used, or provide a chemical functionalization. A surface comprising the flakes is also tolerant of surface cleaning, acid and alkali resistant, able to withstand high pressure and high temperature, and chloride stable. The surface is expected to be more resistant to fouling.

In another method, one or more graphene compounds can be applied over a membrane or supporting layer without a matrix compound. The one or more graphene compounds may function as a reverse osmosis or nanofiltration layer and replace a polymeric barrier membrane layer. In this case, to inhibit leaching of the flakes, it is preferable in an embodiment to do one or more of (a) embed flakes at least in the surface of a supporting membrane layer, (b) cross link the flakes to each other or the supporting layer or both, (c) cover the flakes with a polymer and (d) use a more hydrophobic graphene compound, for example nearly pristine graphene, alone or in a mixture with GO or rGO.

When forming a layer of one or more graphene compounds without a matrix compound, the one or more graphene compounds may optionally be mixed with easily etchable inorganic or organic nanoparticles such as SiO₂. The nanoparticles may preserve pore areas between the flakes of graphene compound. These nanoparticles are removed by selective chemical etching after a layer is formed, for example by water, a solvent or an acid, to open pores between the flakes. Suitable particles include SiO₂, PMMA, polystyrene, sucrose, poly vinyl pyrrolidone (PVP) and other materials suitable for chemical etching. This results in a membrane of desired porosity. The layer can be achieved on a support or in the form of a free-standing membrane. Other particles may also be added, for example TiO₂, or silver particles to provide anti-bacterial properties.

In another method, a top coat may be applied over a layer comprising one or more graphene compounds. The top coat may be used whether the graphene compounds are embedded in a matrix compound or not, and whether the graphene compounds are cross linked or otherwise bonded or not. The top coat helps prevent the graphene compounds from washing or leaching out of the membrane. For example, a top coat may be made of a polymer, for example PVA cross linked with ethylene diamine tetra propoxylate (EDTP) or polyamide epichlorohydrin (PAE). The top coat may be, for example, 1 to 5 nm thick.

A conventional reverse osmosis (RO) membrane may have a polyamide barrier layer up to a few hundreds of nm thick, which is about 100 times thicker than a graphene, GO or rGO flake. Even if a deposit of one or more graphene compounds forming a barrier layer (alternatively called a separation layer) is up to 10 nm thick, or is covered with a top coat, the reduced thickness relative to a conventional RO membrane is likely to allow a lower operating pressure and energy consumption to achieve a selected flux. A thin hydrophilic separation layer, with pore size controlled by the weight of flakes applied per unit area, is also likely to provide improved salt rejection at low pressure.

A matrix material or a supporting membrane may also be made with an inorganic porous ceramic substrate, for example an alumina, zirconia or titania substrate. A membrane made with ceramic materials and one or more graphene compounds can withstand high temperatures, for example 100° C. or more, provided that the membrane has no other components or only uses other components, such as polymers, that are selected for high temperature use. Ceramic materials also withstand harsh environments such as exposure to highly acidic or basic solutions.

Useful ceramic materials include TiO₂, ZrO₂, Al₂O₃ and SiO₂. In an embodiment, one or more graphene compounds are functionalized and can be deposited over a ceramic substrate by means of an organo-metallic (OM) such as an isopropoxide, butoxide or ethoxide of the ceramic material (Ti, Zr, Al, Si). The metal in the OM binds with the corresponding metal in the ceramic support while also anchoring to the graphene compound.

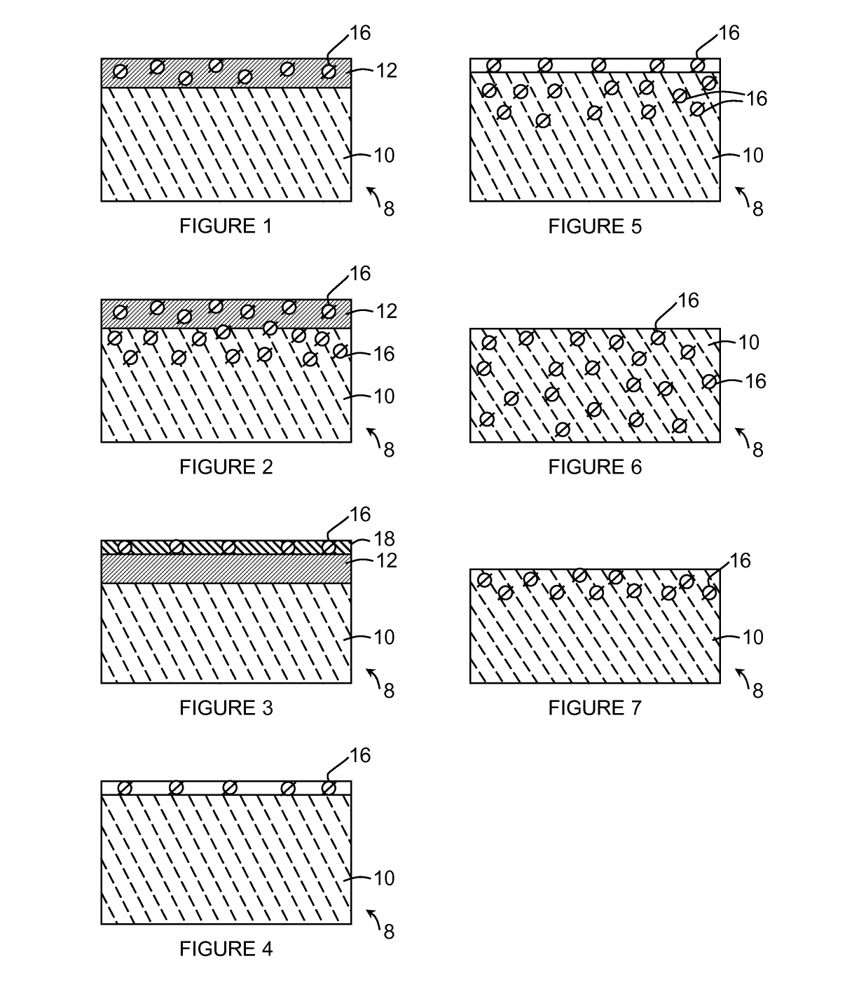

Various exemplary alternative membranes 8 are shown in cross section in FIGS. 1 to 7. Membranes 8 may be made in spiral wound, flat sheet or tubular configurations. Each membrane 8 may be cast on a porous textile substrate, for example a non-woven polyester fabric. Alternatively, the membrane 8 may be self-supporting. The membrane 8 may be used, for example, for filtration or desalination.

In the Figures, porous matrix 10 is a polymeric or ceramic matrix forming, for example, an ultrafiltration or microfiltration membrane. In a spiral wound desalination membrane, the porous matrix 10 may be made, for example, of polysulfone. The porous matrix 10 may be, for example, 20-60 microns thick, more particularly about 40 um thick.

Dense matrix 12 is a polymeric matrix, optionally a TFC membrane, forming a reverse osmosis or nanofiltration membrane. A dense matrix 12 may be in the range of 10-250 nm thick, more particularly 10-100 nm thick.

Flakes 16 are flakes of one or more graphene compounds. In a single membrane 8, the flakes 16 can comprise a single type of graphene compound or a mixture of graphene compounds. In embodiments, in FIGS. 1, 2, 3, 6 and 7, graphene oxide (GO), reduced graphene oxide (rGO) and further functionalized forms of GO and rGO are used. In FIGS. 4 and 5, the flakes 16 form a layer substantially without a matrix material. In these cases, the flakes 16 are graphene, a mixture of graphene and GO or rGO, functionalized graphene, or a mixture of graphene and GO or rGO wherein at least one is functionalized. A layer of flakes 16 without a matrix may be 1-20, more particularly 1-10, nm thick.

Top coat matrix 18 is a polymeric matrix applied over a reverse osmosis or nanofiltration membrane. A top coat matrix 18 may be, for example, in the range of 1-10 nm thick, more particularly 1-5 nm thick. A top coat matrix 18 is shown in FIG. 3 wherein it contains the only flakes 16 in the membrane. Optionally, though not shown, a top coat 18, with or without flakes 16, may also be added over the membranes 8 in FIGS. 1, 2, 4 and 5.

In the following paragraphs, some more particular examples are described with reference to the Figures. However, membranes 8 are not limited to these examples.

In FIG. 1, the dense matrix 12 may be a polyamide TFC and the porous matrix 10 may be a polysulfone membrane. But for the flakes 16, this structure is similar to a flat sheet or spiral wound TFC desalination membrane. Alternatively, a flat sheet or spiral wound membrane may be made with the polyamide layer replaced with a dense matrix 12 of another polymer over a polysulfone porous matrix 10. The polymer may be, for example, polyvinyl alcohol (PVA) insolubilized by cross-linking The flakes 16 and PVA result in a more hydrophilic (relative to polyamide) thick supported layer 12 with antifouling properties. The carboxyl groups in GO or rGO may also increase salt rejection by ion rejection particularly in a NF membrane. The membrane may have increased permeability or reduced energy consumption relative to conventional polyamide thin film composite membranes. Since the dense matrix is less than 100 nm thick in an embodiment, the flakes 16 may be dispersed throughout the dense matrix 12 whether they are provided in one of the reactants or applied over the reactants.

In the example above, EDTP may act as a cross-linker for the PVA and between the graphene compound and the PVA. The PVA has a desirable low contact angle. However, other thermosetting polymers may be used in place of the PVA such as polyvinyl acetate (PVAc), poly(vinyl methyl ether) (PVME) and polyvinyl sulfate (PVS). Flakes 16 of a graphene compound may also be complexed with other compounds such as chitosan or N-isopropyl acrylamide (NIPAAm). In these cases, flakes 16 are bonded through their functional groups to each other or to the dense matrix 12 polymer. This makes the graphene compounds resistant to being washed even when used in a very fine sheet. In contrast, a simple mat of graphene oxide may be removed by a flow of water across the surface of the mat. With sufficient cross-linking or other chemical bonds, a layer of one or more graphene compounds is able to span pores in an ultrafiltration membrane rather than filling the pores.

In FIG. 2, a membrane 8 is made with the same layers as in FIG. 1. However, in this example, flakes 16, more particularly of GO or rGO or a functionalized derivative, are dispersed on to the porous matrix 10 before the dense matrix 12 is added. The flakes 16 are added after the porous matrix 10 is coated on a substrate or otherwise cast, but before the porous matrix 10 cures. The flakes 16 may be added, for example, by spray coating or rod coating. The flakes 16 may be carried in a solvent of the porous matrix 10 or another compatible liquid. In an embodiment, the flakes 16 could also be dispersed in a dope used to make the porous matrix 10 in which case the flakes 16 will be dispersed throughout the porous matrix 10. Adding the flakes 16 during the formation of the porous matrix 10, particularly to the surface of the porous matrix 10, helps adhere the thick supported layer 12 to the porous support 10.

In FIG. 3, a membrane has a porous matrix 10 and a dense matrix 12 of polyamide as in a conventional thin film composite RO or NF membrane. For example, the porous matrix 10 may be polysulfone and the dense matrix 12 may be made of polyamide. A top coat matrix 18 is added over the dense matrix 12. The top coat matrix 18 thin film or layer comprises flakes 16 dispersed in a polymer such as insolubilized PVA. The top coat matrix 18 with flakes 16 may function as an additional barrier layer, or make the membrane 8 more hydrophilic or provide antifouling properties. The hydrophilic nature of the flakes 16 counters the increased thickness of the membrane 8 to maintain its permeability.

In FIG. 4, a porous matrix 10, for example a polysulfone ultrafiltration membrane, is coated with a layer of flakes 16. The flakes 16 may be a single compound, for example graphene or functionalized graphene. A dispersion of flakes 16 in a liquid is applied to the porous matrix 10 for example by filtration deposition or by spray coating or rod coating. The liquid may be, for example, water, an aqueous solution, for example a surfactant in water, or an organic solvent. The weight of flakes 16 per unit surface area is sufficient to provide, for example, 1 to 10 layers of flakes 16 with pores formed between them. The flakes 16 act as the barrier layer of the membrane, for example as a nanofiltration or reverse osmosis layer. Compared to a conventional polyamide thin film composite membrane, the flakes 16 may have increased permeability and antifouling properties. In an embodiment, the flakes 16 are functionalized to provide bonds between the flakes 16 or with the porous matrix 10.

Alternatively, the flakes 16 may comprise two or more compounds, more particularly graphene or functionalized graphene with GO, rGO, functionalized GO or functionalized rGO. The addition of GO or rGO can enhance adhesion between graphene particles. However, since GO and r-GO are highly water dispersible, in an embodiment they are not used alone in an active top layer exposed to a scouring stream of water as in a spiral wound element.

In any of the examples described above for FIG. 4, the porous matrix 10 may be a ceramic ultrafiltration or microfiltration membrane. A ceramic membrane of titania, alumina, zirconia or silica may be stable in temperatures up to 1000° C. The flakes 16, and the membrane 8 as a whole, may be temperature stable up to about 400° C.

In FIG. 5, the membrane 8 is similar to the membranes 8 of FIG. 4. However, in FIG. 5, flakes 16, more particularly of GO or rGO, are incorporated into the porous matrix 10 as described for FIG. 2. The flakes 16 in the porous support 10 help adhere the flakes 16 deposited over the porous support 10.

In FIG. 6, flakes 16 are dispersed in a porous matrix 10 before it is solidified. The porous matrix 10 may be polymeric or ceramic. The porous matrix 10 may be an ultrafiltration membrane or a microfiltration membrane. The flakes 16 make the membrane 8 more hydrophilic, enhance flux and reduce membrane compaction.

In FIG. 7, the membrane 8 is similar to the membrane of FIG. 6. However, the flakes 16 are applied to the surface of the porous matrix 10 before it cures. The flakes 16 may be applied dispersed in a solvent of the porous matrix. The lfakes 16 may make the surface of the porous matrix more hydrophilic. Alternatively, the flakes 16 may be provided in such an amount that a microfiltration membrane becomes tighter or is converted into an ultrafiltration membrane. An ultrafiltration membrane may be made tighter or converted to a nanofiltration membrane.

This written description uses examples to disclose the invention and also to enable any person skilled in the art to practice the invention including making and using any devices or systems and performing any incorporated methods. Specific parameters are intended to provide an example only and are not essential. The patentable scope of the invention is defined by the claims, and may include other examples that occur to those skilled in the art.

What is claimed is:

1. A membrane comprising:
a porous matrix layer; and,
one or more graphene compounds.

2. The membrane of claim 1 wherein the one or more graphene compounds are provided in a layer over the porous matrix layer.

3. The membrane of claim 1 wherein the one or more graphene compounds are provided in the porous matrix layer.

4. The membrane of claim 1 wherein the one or more graphene compounds are selected from the group consisting of graphene, functionalized graphene, graphene oxide, functionalized graphene oxide, reduced graphene oxide, functionalized reduced graphene oxide and combinations thereof.

5. The membrane of claim 2 wherein the one or more graphene compounds are dispersed in a polymer in the layer over the porous matrix layer.

6. The membrane of claim 5 wherein the polymer is formed by interfacial polymerization.

7. The membrane of claim 6 wherein the polymer comprises polyamide.

8. The membrane of claim 5 wherein the polymer is selected form the group consisting of: insolubilized polyvinyl alcohol, polyvinyl acetate, poly(vinyl methyl ether), chitosan, and polyvinyl sulphate, all, with or without a crosslinker, and N-isopropylacrylamide with or without Acrylic acid or acryl amide.

9. The membrane of claim 5 wherein the polymer is insolubilized polyvinyl alcohol.

10. The membrane of claim 1 wherein the one or more graphene compounds comprises a graphene compound functionalized with amine or carbonyl chloride groups.

11. The membrane of claim 1 wherein the one or more graphene compounds comprises a graphene compound functionalized with polyethylene glycol.

12. The membrane of claim 1 wherein the one or more graphene compounds comprises a graphene compound functionalized with acyl chloride or sulphonyl chloride groups.

13. The membrane of claim 1 wherein the one or more graphene compounds comprises a graphene compound functionalized with one or more functional groups selected from the group consisting of: amine, carbonyl chloride, acyl chloride, and sulphonyl chloride.

14. The membrane of claim 2 further comprising a top coat layer.

15. The membrane of claim 2 further comprising an intermediate dense layer between the porous matrix layer and the layer comprising one or more graphene compounds.

16. The membrane of claim 15 wherein the intermediate dense layer comprises polyamide.

17. The membrane of claim 2 wherein the one or more graphene compounds in the layer over the porous matrix layer comprise graphene or functionalized graphene substantially without a matrix material.

18. The membrane of claim 2 wherein the one or more graphene compounds in the layer over the porous matrix layer comprises graphene or functionalized graphene and graphene oxide, reduced graphene oxide, functionalized graphene oxide or functionalized reduced graphene oxide substantially without a matrix material.

19. The membrane of claim 1 wherein the one or more graphene compounds are provided in a layer over the porous matrix layer and in the porous matrix layer.

20. The membrane of claim 1 wherein the porous matrix layer comprises polysulfone.

21. The membrane of claim 1 wherein the porous matrix layer comprises a ceramic.

22. The membrane of claim 3 wherein the one or more graphene compounds in the porous matrix layer increase the rejection of the porous matrix layer.

23. A method of making a membrane comprising steps of:
coating a substrate with a polymeric membrane solution;
dispersing flakes comprising one or more of graphene compounds on or in the polymeric membrane solution;
curing the polymeric membrane solution to form a porous support; and,
coating the porous support with a supported layer comprising one or more graphene compounds.

24. The method of claim 23 wherein coating the porous support with a supported layer comprising one or more graphene compounds comprises filtering a dispersion of flakes through the porous support.

25. The method of claim 23 wherein coating the porous support with a supported layer comprising one or more graphene compounds comprises dispersing flakes on or in at least one polymeric reactant.

26. A method of making a membrane comprising:
coating a porous support in membrane with a polymer and dispersing flakes on or in at least one polymeric reactant.
